(19) United States
(12) Patent Application Publication
(10) Pub. No.: US 2025/0331968 A1
(43) Pub. Date: Oct. 30, 2025

(54) REMOVABLE DENTURES DEVICE AND REMOVABLE DENTURES DEVICE ASSEMBLY METHOD

(71) Applicant: Industrial Technology Research Institute, Hsinchu (TW)

(72) Inventors: Wu-Jung TSAI, Tainan City (TW); Wei-Chin HUANG, Tainan City (TW); Yu-Hsuan SU, Kaohsiung City (TW)

(21) Appl. No.: 18/673,385

(22) Filed: May 24, 2024

(30) Foreign Application Priority Data
Apr. 29, 2024 (TW) 113116015

(51) Int. Cl. A61C 13/10; A61C 13/01

(52) U.S. Cl. CPC A61C 13/1026; A61C 13/01; A61C 13/102

(57) ABSTRACT

A removable dentures device includes a denture base, a denture framework, at least one buffer element and at least one denture crown assembly. The denture framework is provided on the denture base. The buffer element includes buffer body and cutting groove. The buffer body is provided on the framework, and the cutting groove is formed on a side surface of the buffer body. The denture crown assembly includes denture crown body and accommodation groove, and the accommodation groove is formed on the bottom of the denture crown body. The buffer body is provided inside the accommodation groove. In addition, a removable dentures device assembly method is also proposed.

### CROSS REFERENCE TO RELATED APPLICATION

All related applications are incorporated by reference. The present application is based on, and claims priority from, Taiwan Application Serial Number 113116015, filed on Apr. 29, 2024, the disclosure of which is hereby incorporated by reference herein in its entirety.

### TECHNICAL FIELD

The present disclosure relates to a removable dentures device and a removable dentures device assembly method, and more particularly to a removable dentures device with a stress buffer structure and a removable dentures device assembly method.

### BACKGROUND

In the prior art, there mainly are a three-piece removable denture composed of a denture crown, a dental framework and a denture base and a four-piece removable denture composed of a denture crown, a gum-color base, a denture framework and a denture base. They are mainly configured as follows: the denture crown is adhered to the denture framework/the denture crown is provided on the gum-color bases and the gum-color bases are adhered to the denture framework, the denture framework is adhered to the denture base, and the denture base rests on the gums missing teeth. Bracket buckles of the denture framework are fastened to the adjacent teeth, and the missing teeth are replaced by the installation of removable dentures for biting and chewing.

In the configuration structure of the above-mentioned removable dentures, the bite force of the denture crown is mainly in the vertical direction. Since the bottom end of the denture crown/the bottom end of the gum-color base is in direct rigid contact with the denture framework, the bite force endured will be directly transmitted to the denture framework and the denture base. This causes the denture base to be easily damaged and shortens its lifespan. Furthermore, the main support for removable dentures is provided by the denture framework, and the gums will also bear the same stress transmitted from the denture base, causing burden or injury to the gums.

In addition, the current denture framework does not have a positioning and guiding structure suitable for automated assembly, and it will take more time to assemble.

### SUMMARY

An embodiment of the present disclosure provides a removable dentures device, capable of buffering and dispersing bite force borne by a denture crown assembly, reducing stress transmission to a denture framework and a denture base, and avoiding damage of the framework and the base to increase the life of the removable dentures device.

Another embodiment of the present disclosure provides a removable dentures device assembly method, capable of improving assembly efficiency.

An embodiment of the present disclosure proposes a removable dentures device, including: a denture base; a denture framework, provided on the denture base; at least one buffer element, including a buffer body and at least one cutting groove, wherein each of the buffer bodies is respectively provided on the denture framework, the at least one cutting groove is respectively formed on a side surface of the buffer body; and a denture crown assembly, including at least one accommodation groove, each of the buffer bodies provided inside the accommodation groove corresponding thereto.

Another embodiment of the present disclosure proposes a removable dentures device assembly method, including the following steps: a positioning step, including the following steps: taking images of a denture framework provided with at least one buffer element, and a denture crown assembly to obtain a denture framework image of the denture framework and a denture crown assembly image of at least one accommodation groove of the denture crown assembly; respectively determining a direction of a corresponding positioning arc surface of each of the buffer elements on the denture framework, and a direction of a corresponding positioning arc surface of each of the accommodation grooves of the denture crown assembly from the denture framework image and the denture crown assembly image; and respectively determining a positions and direction of the denture framework correspondingly provided on the buffer elements, and positions and directions of the accommodation grooves according to the direction of the corresponding positioning arc surface of each of the buffer elements and the direction of the corresponding positioning arc surface of each of the accommodation grooves; and an engagement step, positioning and engaging the denture crown assembly and the denture framework according to the positions and direction of the buffer elements and the accommodation grooves.

Based on the above, the present disclosure designs a buffer element with a stress buffering structure on the denture framework of the removable dentures device, and uses the cutting grooves in the buffer element as a stress buffering structure to buffer and disperse the stress transmission at the contact point between the lower edge (bottom) of the denture framework and the denture base, which can reduce the vertical bite force transmitted to the denture base and the gums supporting the denture base. It can buffer and disperse the bite force borne by the denture crown assemblies and enhance the durability (life) and comfort of the removable dentures device while avoiding gums damage.

Furthermore, the present disclosure uses the direction of the positioning arc surface for positioning in the removable denture device assembly method, which greatly reduces the assembly time.

In order to make the present disclosure more obvious and understandable, embodiments are specifically cited below and described in detail with reference to the attached drawings.

### BRIEF DESCRIPTION OF THE DRA WINGS

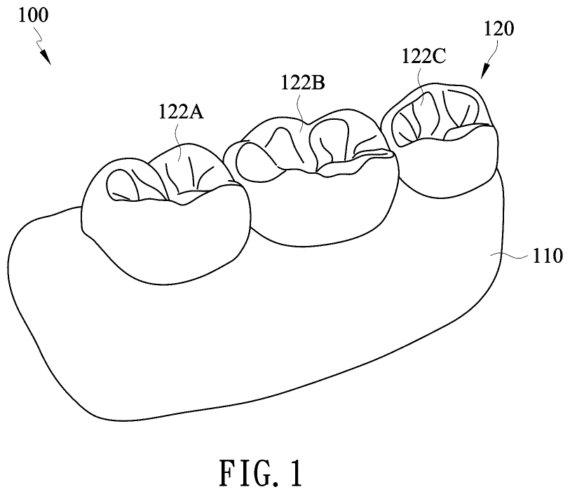

FIG. 1 is a perspective view of an embodiment of a removable dentures device according to the present disclosure;

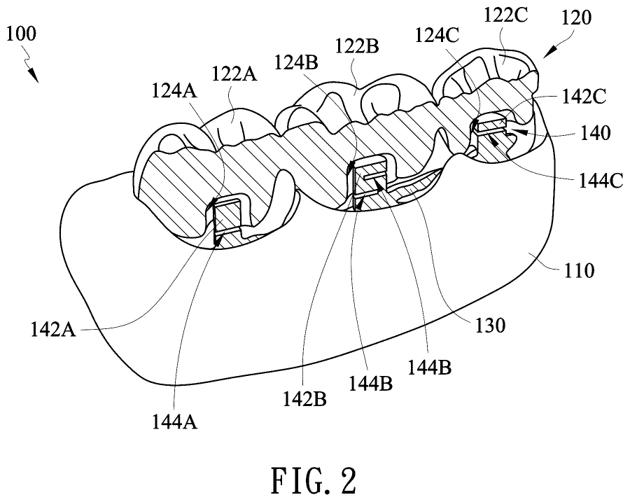

FIG. 2 is a cross-sectional view of the removable dentures device of FIG. 1;

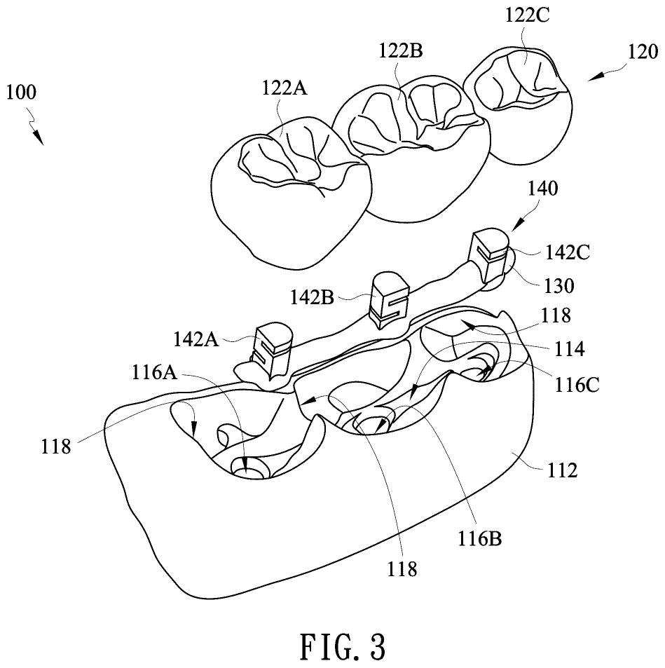

FIG. 3 is an exploded view of the removable dentures device of FIG. 1;

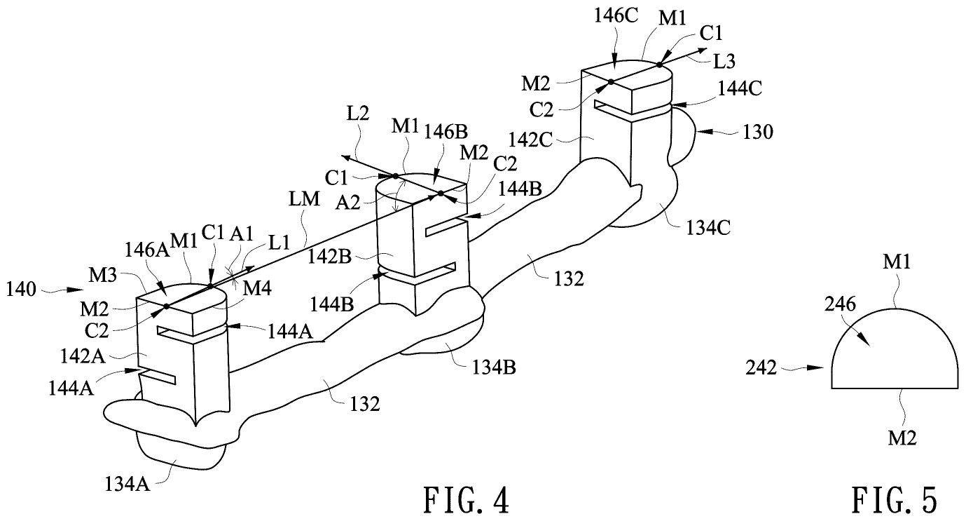

FIG. 4 is a perspective view of a denture framework and a buffer element according to the present disclosure;

FIG. 5 is a schematic view of another embodiment of a positioning structure of a buffer element according to the present disclosure;

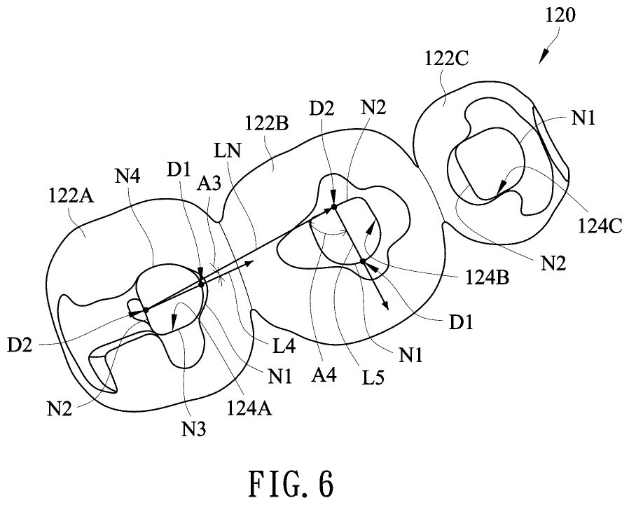

FIG. 6 is a schematic view of a bottom of a denture crown assembly according to the present disclosure;

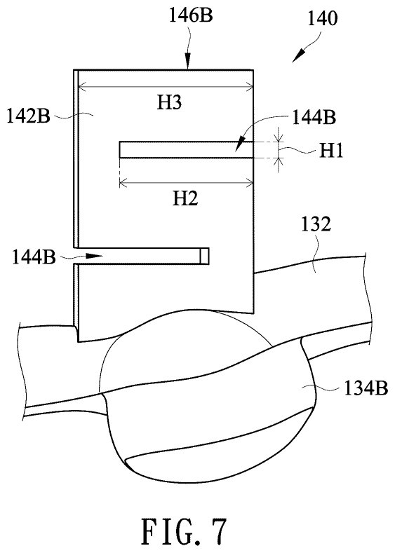

FIG. 7 is a schematic view of a side surface of an embodiment of a buffer element according to the present disclosure;

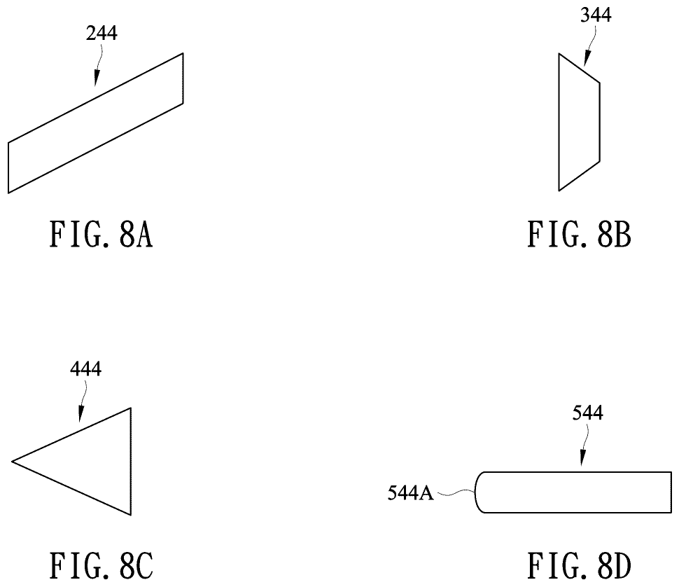

FIGS. 8A to 8D respectively are a schematic view of aside surface of a cutting groove according to the present disclosure;

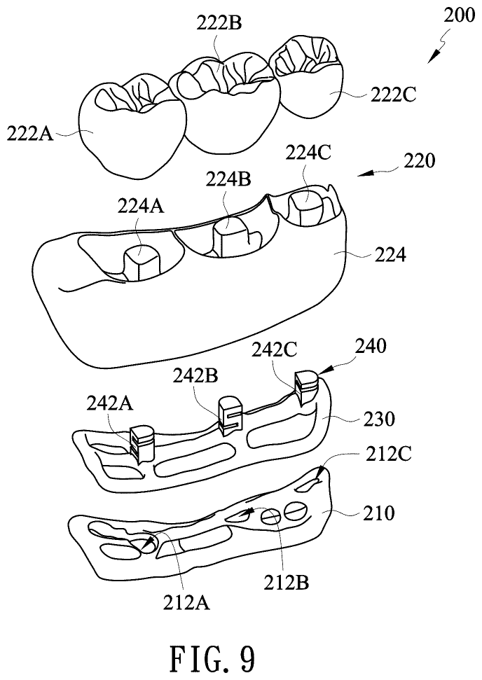

FIG. 9 is an exploded view of another embodiment of a removable dentures device according to the present disclosure;

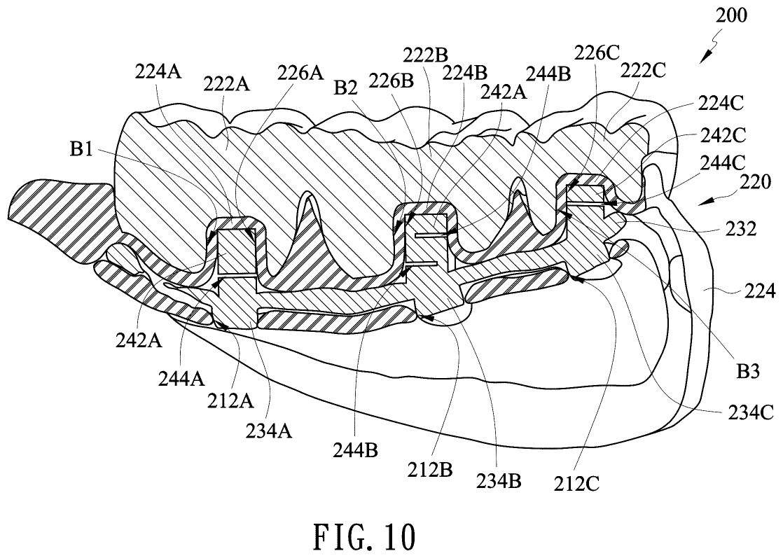

FIG. 10 is a cross-sectional view of another embodiment of a removable dentures device according to the present disclosure;

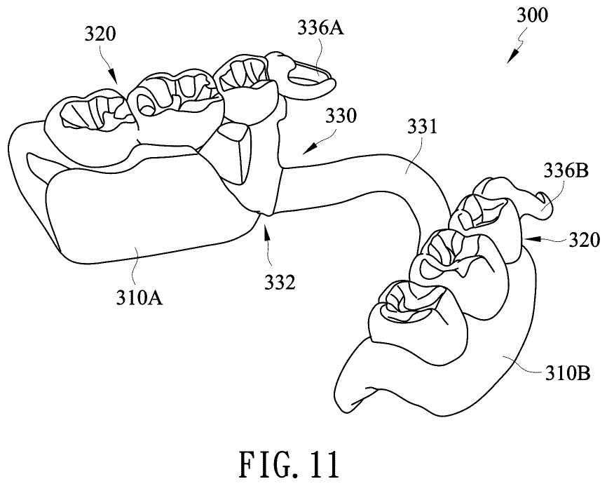

FIG. 11 is a perspective view of yet another embodiment of a removable dentures device according to the present disclosure;

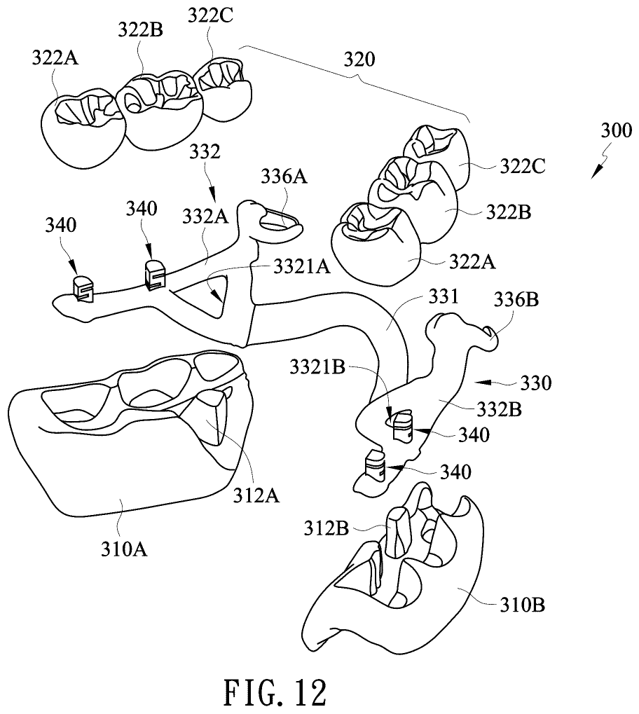

FIG. 12 is an exploded view of yet another embodiment of a removable dentures device according to the present disclosure; and

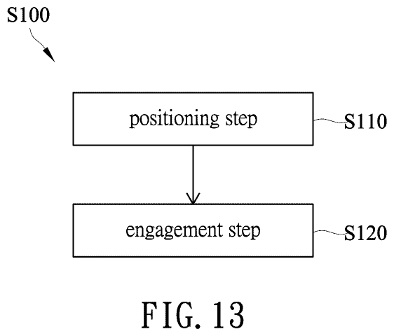

FIG. 13 shows a removable dentures device assembly method according to the present disclosure.

### DETAILED DESCRIPTION

The following embodiments are enumerated and described in detail with reference to the accompanying drawings, but the provided embodiments are not intended to limit the scope of the present disclosure. In addition, the drawings are for illustrative purposes only and are not drawn to original size. To facilitate understanding, the same elements will be identified with the same symbols in the following description.

The terms “including”, “comprising”, “having”, etc. mentioned in the present disclosure are all open terms, that is, they mean “comprising but not limited to”.

In the description of each embodiment, when terms such as “first”, “second”, “third”, “fourth”, etc. are used to describe elements, they are only used to distinguish these elements from each other, and there is no restriction on the order or importance of these elements.

In the description of various embodiments, the so-called “coupling” or “connection” may refer to two or more components making direct physical or electrical contact with each other, or indirectly making physical or electrical contact with each other. “Coupling” or “connection” can also refer to the mutual operation or action of two or more components.

FIG. 1 is a perspective view of an embodiment of a removable dentures device according to the present disclosure. FIG. 2 is a cross-sectional view of the removable dentures device of the present disclosure of FIG. 1. FIG. 3 is an exploded view of the removable dentures device of the present disclosure of FIG. 1. FIG. 4 is a perspective view of a denture framework and a buffer element according to the present disclosure. Referring to FIGS. 1 to 4, a removable dentures device 100 of the present disclosure includes a denture base 110, a denture crown assembly 120, a denture framework 130, and at least one buffer element 140, where the denture base 110 can rest on patient's gums (not shown in the figures), the denture framework 130 is provided on the denture base 110, the at least one buffer element 140 is provided on the denture framework 130 and extended outward, the denture crown assembly 120 is provided on the denture framework 130 and used to combine with the at least one buffer element 140.

The denture crown assembly 120 includes a first denture crown body 122A, a second denture crown body 122B, a third denture crown body 122C, a first accommodation groove 124A, a second accommodation groove 124B, and a third accommodation groove 124C, where the second denture crown body 122B is positioned between the first denture crown body 122A and the third denture crown body 122C, and the first accommodation groove 124A, the second accommodation groove 124B and the third accommodation groove 12a4C are respectively formed on the bottoms of the corresponding first denture crown body 122A, second denture crown body 122B and third denture crown body 122C.

Referring to FIGS. 2 to 4, the denture base 110 includes a base body 112, a framework groove body 114, a first column body groove 116A, a second column body groove 116B, a third column body groove 116C, and three denture crown grooves 118, where each of the denture crown grooves 118 is concavely formed on the upper side of the base body 112, the number of the denture crown grooves 118 can be determined based on the number of denture crown bodies (such as the first denture crown body 122A, the second denture crown body 122B, and the third denture crown body 122C) of the denture crown assembly 120.

The first column body groove 116A, the second column body groove 116B, the third column body groove 116C and the framework groove body 114 are respectively concavely formed on the base body 112, and the framework groove body 114 is in communication with the first column body groove 116A. the second column body groove 116B, the third column body groove 116C, and the first column body groove 116A, the second column body groove 116B, the third column body groove 116C and the framework groove body 114 are respectively in communication with the denture crown grooves 118. The first column body groove 116A, the second column body groove 116B, the third column body groove 116C and the framework groove body 114 of the present disclosure may be selected according to the type of the denture framework 130.

Referring to FIGS. 2 to 4, the denture framework 130 includes a framework body 132, a first connection column body 134A, a second connection column body 134B, and a third connection column body 134C, the first connection column body 134A, the second connection column body 134B and the third connection column body 134C are respectively provided in the different positions of the framework body 132. The first connection column body 134A, the second connection column body 134B and the third connection column body 134C are respectively provided inside the corresponding first column body groove 116A, second column body groove 116B and third column body groove 116C, and the frame body 132 is provided in the framework groove body 114.

In the embodiment, the number of the at least one buffer element 140 is three, these three buffer elements 140 respectively include a first buffer body 142A and two first cutting grooves 144A, a second buffer body 142B and two second cutting grooves 144B, and a third buffer body 142C and a third cutting groove 144C, where the first buffer body 142A, the second buffer body 142B and the third buffer body 142C are respectively provided on the different positions of the denture framework 130. The two first cutting grooves 144A are formed on a side surface of the first buffer body 142A, the two second cutting grooves 144B are formed on a side surface of the second buffer body 142B, and the third cutting groove 144C is formed on a side surface of the third buffer body 142C.

In the embodiment, the number of the cutting grooves can be adjusted according to actual conditions, but the first buffer body 142A, the second buffer body 142B and the third buffer body 142C must be arranged correspondingly to the at least one cutting groove respectively, so as to provide space for buffering and dispersing stress.

As shown in FIG. 2, the first buffer body 142A, the second buffer body 142B and the third buffer body 142C are provided inside the corresponding first accommodation groove 124A, the second accommodation groove 124B and the third accommodation groove 124C, so that the buffer element 140 is provided inside the denture crown assembly 120.

Among these, the number of the denture crown bodies (such as the first denture crown body 122A, the second denture crown body 122B, the third denture crown body 122C) of the denture crown assembly 120 of the present disclosure and the number of the buffer elements 140 are, for example, three, but the number of the denture crown bodies (such as the first denture crown body 122A, the second denture crown body 122B, the third denture crown body 122C) of the denture crown assembly 120 and the number of the buffer elements 140 can be adjusted according to actual conditions, for example, one or two, the numbers of the both can be consistent, or they can be adjusted to be different according to needs. In addition, the column body grooves and the denture crown grooves of the denture base 110, and the connection column bodies of the denture frameworks 130 all are three, but it is not limited thereto and can be adjusted according to the number of buffer elements 140.

Under this arrangement, the present disclosure designs the buffer element 140 with stress buffering structure on the denture framework 130 of the removable dentures device 100; the cutting grooves (such as the first cutting groove 144A, the second cutting groove 144B and the third cutting groove 144C) of the buffer element 140 is used to be the stress buffering structure, thereby buffering and dispersing the stress transmission at the contact of the lower edge of the denture framework 130 with the denture base 110, which can reduce the transmission of the vertical bite force to the denture base 110 and the gums leaned against by the denture base 110, capable of buffering and dispersing the bite force borne by the denture crown assembly 120 to increase the durability (life) and comfortability of the removable dentures device 100, and at the same time, to avoid gums damage.

In an embodiment, the buffer element 140 may be made of titanium, titanium alloys, Cobalt-Chromium Alloys, Stainless Steel, which in addition to having structural strength to assist the denture framework as support, the cutting grooves (such as the first cutting groove 144A, the second cutting groove 144B and the third cutting groove 144C) of the buffer element 140 can serve as a buffer space for vertical stress transmission.

In addition, as shown in FIG. 2, in an embodiment, the denture base 110 can be filled with adhesive, allowing the adhesive to be filled inside the first accommodation groove 124A, the second accommodation groove 124B, the third accommodation groove 124C, the two first cutting grooves 144A, the two second cutting grooves 144B and the third cutting groove 144C, so as to have the function of connection and sealing due to the filling.

Continue to refer to FIG. 4, the first buffer body 142A, the second buffer body 142B and the third buffer body 142C respectively include a first positioning structure 146A, a second positioning structure 146B and a third positioning structure 146C, and the first positioning structure 146A, the second positioning structure 146B and the third positioning structure 146C each includes a positioning arc surface M1, a plane M2 and two side planes M3 and M4, where the positioning arc surface M1 and the plane M2 are respectively positioned on the two opposite sides, and these two side planes M3 and M4 are respectively connected between the positioning arc surface M1 and the plane M2, allowing the first positioning structure 146A, the second positioning structure 146B and the third positioning structure 146C to be a combination of one arc surface and three planes. In other words, the first buffer body 142A, the second buffer body 142B and the third buffer body 142C present a column shape that is a combination of an arc surface and three planes.

However, the present disclosure is not limited thereto. As shown in FIG. 5, the positioning structure 246 included in the buffer body 242 is formed by a positioning arc surface M1 and a plane M2, forming a combination of an arc surface and a plane.

FIG. 6 is a schematic view of a bottom of a denture crown assembly according to the present disclosure. Referring to FIGS. 4 and 6, the sizes of the first accommodation groove 124A, the second accommodation groove 124B and the third accommodation groove 124C of the present disclosure are slightly larger than the sizes of the first buffer body 142A, the second buffer body 142B and the third buffer body 142C, so as to allow the first buffer body 142A, the second buffer body 142B and the third buffer body 142C to be provided in, and the shapes of the first buffer body 142A, the second buffer body 142B and the third buffer body 142C respectively match the shapes of the first accommodation groove 124A, the second accommodation groove 124B and the third accommodation groove 124C.

As shown in FIGS. 4 and 6, the first positioning structure 146A. the second positioning structure 146B and the third positioning structure 146C are the combination of an arc surface and three planes, and the first accommodation groove 124A, the second accommodation groove 124B and the third accommodation groove 124C each also includes a positioning arc surface N1, a plane N2 and two side plane N3 and N4, where the positioning arc surface N1 and the plane N2 are respectively positioned on the two opposite sides, and these two side plane N3 and N4 are respectively connected between the positioning arc surface N1 and the plane N2. Naturally, the shape of the accommodation groove of the denture crown assembly 120 can also be adjusted according to the shape of the positioning structure 246 as shown in FIG. 5.

In an embodiment, the directions of the positioning arc surface M1 of the first positioning structure 146A, the positioning arc surface M1 of the second positioning structure 146B and the positioning arc surface M1 of the third positioning structure 146C may be different. It needs to explain that a connection direction L1 defining a center C2 of the plane M2 of the first positioning structure 146A to a center C1 of the positioning arc surface M1 is the direction of the positioning arc surface M1 of the first positioning structure 146A, a connection direction L2 defining a center C2 of the plane M2 of the second positioning structure 146B to a center C1 of the positioning arc surface M1 is the direction of the positioning arc surface M1 of the positioning arc surface 146B, and a connection direction L3 defining a center C2 of the plane M2 of the third positioning structure 146C to a center C1 of the positioning arc surface M1 is the direction of the positioning arc surface M1 of the third positioning structure 146C.

Taking FIG. 4 as an example, the present disclosure designs that the directions of the arc surfaces of the adjacent positioning structures are different, for example: the connection direction L2 of the second positioning structure 146B is respectively different from the connection direction L1 of the first positioning structure 146A and the connection direction L3 of the third positioning structure 146C, and the connection direction L1 of the first positioning structure 146A and the connection direction L3 of the third positioning structure 146C face the same side. In other embodiments, it can design according to actual situations that the directions of the positioning arc surfaces M1 of the first positioning structure 146A, the second positioning structure 146B and the third positioning structure 146C are the same.

In addition, the connection directions of any two of the buffer elements 140 can be used to determine the position and the direction of the buffer element 140 provided on the denture framework 130. As shown in FIG. 4, there is a positioning point connection direction LM from the center C2 of the plane M2 of the first positioning structure 146A to the center C2 of the plane M2 of the second positioning structure 146B. There is an included angle A1 between the positioning point connection direction LM and the connection direction L1 of the first positioning structure 146A, and there is an included angle A2 between the positioning point connection direction LM and the connection direction L2 of the second positioning structure 146B. The positions and directions of the first buffer body 142A and the second buffer body 142B on the denture framework 130 can be determined through the positioning point connection direction LM and the included angles A1 and A2.

Similarly, the shapes of the first accommodation groove 124A, the second accommodation groove 124B and the third accommodation groove 124C match the shapes of the corresponding first positioning structure 146A, second positioning structure 146B and third positioning structure 146C, so that the directions of the positioning arc surfaces N1 of the first accommodation groove 124A, the second accommodation groove 124B and the third accommodation groove 124C are the same as the directions of the positioning arc surfaces M1 of the first positioning structure 146A, the second positioning structure 146B and the third positioning structure 146C. For example, taking FIG. 6 as an example, the direction of the positioning arc surface N1 of the first accommodation groove 124A is a connection direction L4 from a center D2 of a plane N2 to a center D1 of the positioning arc surface N1; the direction of the positioning arc surface N1 of the second accommodation groove 124B is a connection direction L5 from a center D2 of a plane N2 to a center D1 of the positioning arc surface N1. The connection direction L5 of the second accommodation groove 124B is different from the connection direction L4 of the first accommodation groove 124A. Similarly, the type of the third accommodation groove 124C is the same as the third positioning structure 146C, allowing the direction of the third accommodation groove 124C to be the same as the direction of the first accommodation groove 124A, and the direction of the third accommodation groove 124C is not the same as the direction of the second accommodation groove 124B.

In addition, the accommodation grooves have the same identification criteria, there is a positioning point connection direction LN from the center D2 of the plane N2 of the first accommodation groove 124A to the center D2 of the plane N2 of the second accommodation groove 124B. There is an included angle A3 between the positioning point connection direction LN and the connection direction L4 of the first accommodation groove 124A, and there is an included angle A4 between the positioning point connection direction LN and the connection direction L5 of the second accommodation groove 124B; the positions and directions of the first accommodation groove 124A and the second accommodation groove 124B can be determined through the positioning point connection direction LN and the included angles A3 and A4. Furthermore, the denture crown assembly 120, the buffer element 140 and the denture framework 130 connected thereto can be assembled and positioned through the positioning point connection direction LN, the included angle A3, the included angle A4, and the above positioning point connection direction LM, the included angle A1, and the included angle A2.

FIG. 7 is a schematic view of a side surface of an embodiment of a buffer element according to the present disclosure. Referring to FIG. 7, the buffer element 140, for example, takes the second buffer body 142B in FIG. 4 as an example, the second cutting groove 144B is a groove body with a side opening formed from the side surface of the second buffer body 142B toward the inside of the second buffer body 142B. The range of the height H1 of the opening of the second cutting groove 144B, for example, is between 0.05 mm and 1 mm. The size of the depth H2 of the opening of the second cutting groove 144B is 60% to 90% of the size of the width H3 of the second buffer body 142B, where the width H3 here may be the width of the plane M2 as shown in FIG. 4.

In addition, in an embodiment, the direction of the depth H2 of the opening of the second cutting groove 144B is parallel to the direction of the second positioning structure 146B on the top surface of the second buffer body 142B. In other embodiments, the direction of the depth H2 of the opening of the second cutting groove 144B is oblique cutting, allowing the direction of the depth H2 of the opening of the second cutting groove 144B to be not parallel to the direction of the second positioning structure 146B on the top surface of the second buffer body 142B.

In an embodiment, as shown in FIG. 7, the side surface shape of the first cutting groove 144A is a rectangle. The present disclosure is not limited thereto, as FIG. 8A shows, the side surface shape of the cutting groove 244 is a parallelogram; as shown in FIG. 8B, the side surface shape of the cutting groove 344 is a trapezoid; as shown in FIG. 8C, the side surface shape of the cutting groove 444 is a triangle; as shown in FIG. 8D, the side surface shape of the cutting groove 544 is a rectangle with an arc 544A at one end; or the side surface shape of the cutting groove is any combination of non-circular shapes, such as the above rectangle, parallelogram, trapezoid with an arc at one end.

FIG. 9 is an exploded view of another embodiment of a removable dentures device according to the present disclosure. FIG. 10 is a cross-sectional view of another embodiment of a removable dentures device according to the present disclosure. Referring to FIGS. 9 and 10, compared to the three-piece removable dentures device 100 of FIG. 3, a removable dentures device 200 of the present disclosure is a four-piece type, including a denture base 210, at least one denture crown assembly 220, a denture framework 230, and at least one buffer element 240, where the type of the buffer element 240 can refer to the type of the buffer element 140 in the previous embodiments, and will not be described again here.

The types of the denture base 210 and the denture framework 230 can be adjusted according to actual situations; the denture base 210 may be provided with a first column body groove 212A, a second column body groove 212B, and a third column body groove 212C, which respectively are a hole on the frame of the denture base 210; the denture framework 230 correspondingly includes a first connection column body 234A, a second connection column body 234B, and a third connection column body 234C, which are respectively provided on a different position of a framework body 232. The first connection column body 234A, the second connection column body 234B, and the third connection column body 234C are respectively provided inside the corresponding first column body groove 212A, second column body groove 212B and third column body groove 212C, allowing the denture framework 230 to be installed on the denture base 210.

The denture crown assembly 220 includes a first denture crown body 222A, a second denture crown body 222B, a third denture crown body 222C, a gum-color base 224, a first accommodation groove 226A, a second accommodation groove 226B, and a third accommodation groove 226C, where the gum-color base 224 include a first assembly bump 224A, a second assembly bump 224B, and a third assembly bump 224C, which are protruded outward, and the first denture crown body 222A, the second denture crown body 222B and the third denture crown body 222C are correspondingly provided with a first engagement hole B1, a second engagement hole B2, and a third engagement hole B3, and the first assembly bump 224A, the second assembly bump 224B and the third assembly bump 224C are respectively correspondingly provided inside the first engagement hole B1, the second engagement hole B2 and the third engagement hole B3, allowing the first denture crown body 222A, the second denture crown body 222B and the third denture crown body 222C to be respectively provided on the gum-color base 224.

As shown in FIG. 10, the first accommodation groove 226A, the second accommodation groove 226B and the third accommodation groove 226C are hollow holes, which are correspondingly formed on the first assembly bump 224A, the second assembly bump 224B and the third assembly bump 224C of the gum-color base 224, and respectively correspondingly allow the first buffer body 242A, the second buffer body 242B and the third buffer body 242C to be provided therein, so that the buffer element 240 is provided inside the denture crown assembly 220. Thus, the first cutting groove 244A, the second cutting groove 244B and the third cutting groove 244C (like the first cutting groove 144A, the second cutting groove 144B and the third cutting groove 144C, which will not be described in detail here) of the buffer element 240 are used as a stress buffer structure of the four-piece removable dentures device.

FIG. 11 is a perspective view of yet another embodiment of a removable dentures device according to the present disclosure. FIG. 12 is an exploded view of yet another embodiment of a removable dentures device according to the present disclosure. Referring to FIGS. 11 and 12, compared to the above embodiments, a removable dentures device 300 of the present disclosure is a two-side removable dentures device, the components on both sides of which can be the same as a three-piece removable denture device (such as the removable dentures device 100 in FIG. 1) or a four-piece removable dentures device (such as the removable dentures device 200 in FIG. 9). Here, the three-piece removable denture device is used as an example.

Two denture bases 310A and 310B respectively include connection column bodies 312A and 312B, and a framework body 332 of a denture framework 332 has a first section 332A and a second section 332B, which are respectively provided with engagement holes 3321A and 3321B, where the connection column bodies 312A and 312B are respectively inserted in the corresponding engagement holes 3321A and 3321B, allowing the first section 332A and the second section 332B of the framework body 332 to be respectively provided on the corresponding denture bases 310A and 310B.

The denture framework 330 further includes a connection element 331 connected with the left and right sides and buckles 336A and 336B, where the two sides of the connection element 331 are respectively connected to the first section 332A and the second section 332B, the buckle 336A is connected to one end of the first section 332A, the buckle 336B is connected to one end of the second section 332B, and the buckles 336A and 336B are fastened to adjacent teeth (not shown in the figures). The first section 332A and the second section 332B are respectively correspondingly provided with two buffer elements 340, through which the denture crown assemblies 320 are provided on the corresponding first section 332A and second section 332B. The number of the buffer elements 340 can be selected according to the size of the denture crown body of the actual denture crown assembly 320; if the size of the denture crown body of the crown assembly 320 is too small, the assembly can be done without needing the correspondingly provided buffer element 240, for example, in the embodiment, the first denture crown body 322A and the second denture crown body 322B have the correspondingly provided buffer elements 340. However, the third denture crown body 322C is not provided with the corresponding buffer element 340 due to the size, but there is no restriction here. FIG. 13 shows a removable dentures device assembly method according to the present disclosure. Referring to FIG. 13, a removable dentures device assembly method S100 of the present disclosure can be used on the removable dentures devices 100, 200 and 300 mentioned above and a removable dentures device with buffer elements 140, 240, 340. The removable dentures device assembly method S100 includes step S110 to step S120.

Step 110 is a positioning step, including the following steps: first, taking images of the denture framework 130 (or denture frameworks 230, 330) provided with at least one buffer element 140 (or buffer elements 240, 340), and the denture crown assembly 120 (or denture crown assemblies 220, 320) to obtain the denture framework image of the denture framework 130 (or the denture frameworks 230, 330) and the denture crown assembly image of the accommodation groove of the denture crown assembly 120 (or the denture crown assemblies 220, 320), where the accommodation grooves are like the first accommodation groove 124A, the second accommodation groove 124B and the third accommodation groove 124C in FIG. 6, or the first accommodation groove 226A and the second accommodation groove 226B and the third accommodation groove 226C in FIG. 10.

Next, the denture framework image is used to determine the positioning point and direction of each buffer element 140 (or buffer elements 240, 340) on the denture framework 130 (or denture frameworks 230, 330), where the positioning point and direction of the buffer element 140 (or buffer elements 240, 340) is the direction of the positioning arc surface of the buffer element 140 (or buffer element 240, 340). Taking FIG. 4 as an example, the positioning arc surface M1 and the opposite plane M2 of the positioning structure (such as the first positioning structure 146A) on each buffer element 140 (or buffer elements 240, 340) are found out; next, a connection direction from the center of C2 of the plane M2 to the center C1 of the positioning arc surface M1 is set to be the direction of the positioning arc surface M1 of the positioning structure. For example, a connection direction L1 from a center C2 of the plane M2 of the first positioning structure 146A to a center C1 of the positioning arc surface M1 is defined as the direction of the positioning arc surface M1 of the first positioning structure 146A; a connection direction L2 from a center C2 of the plane M2 of the second positioning structure 146B to a center C1 of the positioning arc surface M1 is defined as the direction of the positioning arc surface M1 of the second positioning structure 146B; a connection direction L3 from a center C2 of the plane M2 of the third positioning structure 146C to a center C1 of the positioning arc surface M1 is defined as the direction of the positioning arc surface M1 of the third positioning structure 146C.

Next, the connection direction of any two buffer elements 140 (or buffer elements 240, 340) are used to calculate the position and direction of the denture framework 130 (or the denture frameworks 230, 330) correspondingly provided on the buffer element 140 (or the buffer elements 240, 340). For example, taking FIG. 4 as an example, the center C2 of the plane M2 of each positioning structure (such as the first positioning structure 146A and the second positioning structure 146B) is connected to form a positioning point connection direction LM; next, there is a corresponding included angle (such as the included angle A1 and included angle A2 in FIG. 4) between the positioning point connection direction LM and the connection direction of each positioning structure; the position and direction of the denture framework 130 correspondingly provided on these buffer elements 140 (or buffer elements 240, 340) are determined through the positioning point connection direction LM and these included angles. Whereby, the position of the denture framework 130 (or the denture frameworks 230, 330) can be known.

Next, the denture crown assembly image is used to determine the positioning point and direction of the accommodation groove, where the positioning point and direction of the accommodation groove are the direction of the positioning arc surface of the accommodation groove. Taking FIG. 6 as an example, the positioning arc surface N1 and the opposite plane N2 of the accommodation groove (such as the first accommodation groove 124A) are found; next, a connection direction from the center D2 of the plane N2 to the center D1 of the positioning arc surface N1 is set to be the direction of the positioning arc surface N1 of the accommodation groove.

Next, the connection direction of any two accommodation grooves is used to calculate the position and direction of the accommodation groove. For example, taking FIG. 6 as an example, the center D2 of the plane N2 of each accommodation groove (such as the first accommodation groove 124A and the second accommodation groove 124B) is connected to form a positioning point connection direction LN; next, there is an included angle between the positioning point connection direction LN and the connection direction of each accommodation groove; the positions and directions of these accommodation grooves are determined through the positioning point connection direction LN and these included angles.

The position and direction of these buffer elements 140 (or buffer elements 240, 340) correspondingly provided on the denture framework 130, and the positions and directions of these accommodation grooves can be known through the above step S110. Thereafter, step S120 is performed, which is an engagement step: positioning and engaging the denture crown assembly 120 (or denture crown assemblies 220, 320) and the denture framework 130 (or denture framework 230, 330). For example, based on the position and direction of the buffer element 140 (or buffer elements 240, 340) and the accommodation groove, the robot arm (not shown) is controlled to pick up the denture crown assembly 120 (or denture crown assemblies 220, 320), and position and engage it to the denture framework 130 (or denture frameworks 230, 330).

Since the relative position of the buffer element 140 (or the buffer elements 240, 340) is controlled within the tolerance during production, the assembly speed is improved. In addition, when necessary, a combination of multiple sets of positioning point connection vectors can be used for positioning, which greatly reduces assembly time.

In summary, the present disclosure designs a buffer element with a stress buffering structure on the denture framework of the removable dentures device, and uses the cutting grooves formed on the buffer element as a stress buffering structure to buffer and disperse the stress transmission at the contact point between the lower edge (bottom) of the denture framework and the denture base, which can reduce the vertical bite force transmitted to the denture base and the gums supporting the denture base. It can buffer and disperse the bite force borne by the denture crown assemblies and enhance the durability (life) and comfort of the removable dentures device while avoiding gums damage.

Furthermore, the present disclosure uses the direction of the positioning arc surface for positioning in the removable denture device assembly method, which greatly reduces the assembly time.

Although the present disclosure has been disclosed as above in the form of embodiments, it is not intended to limit the disclosure. Anyone with ordinary knowledge in the technical field may make slight changes and modifications without departing from the spirit and scope of the disclosure, so the scope of protection of the disclosure shall be subject to the scope of the claims attached.

What is claimed is:

1. A removable dentures device, comprising:
a denture base;
a denture framework, provided on said denture base;
at least one buffer element, comprising a buffer body and at least one cutting groove, wherein each of said buffer bodies is respectively provided on said denture framework, said at least one cutting groove is respectively formed on a side surface of said buffer body; and
a denture crown assembly, comprising at least one accommodation groove, each of said buffer bodies provided inside said accommodation groove corresponding thereto.

2. The device according to claim 1, wherein said denture crown assembly comprises at least one denture crown body, each of said accommodation grooves is respectively formed on a bottom of said denture crown body corresponding thereto.

3. The device according to claim 1, wherein said denture crown assembly comprises at least one denture crown body, and a gum-color base, each of said denture crown bodies is provided on said gum-color base, each of said accommodation grooves is respectively formed on a bottom of said gum-color base corresponding thereto.

4. The device according to claim 1, wherein a shape of each of said accommodation grooves matches a shape of said buffer body corresponding thereto.

5. The device according to claim 1, wherein each of said cutting grooves is a groove body from a side surface of said buffer body toward an inside of said buffer body.

6. The device according to claim 1, wherein an opening height of each of said cutting grooves ranges between 0.05 mm to 1 mm.

7. The device according to claim 1, wherein the size of an opening depth of each of said cutting grooves is 60% to 90% of a width size of said buffer body corresponding thereto.

8. The device according to claim 1, wherein a side surface shape of each of said cutting groove is non-circular.

9. The device according to claim 8, wherein said side surface shape of each of said cutting grooves is a rectangle, a parallelogram, or a trapezoid.

10. The device according to claim 9, wherein one end of said rectangle, said parallelogram or said trapezoid is an arc.

11. The device according to claim 1, wherein each of said buffer bodies comprises a positioning structure.

12. The device according to claim 11, wherein each of said positioning structures is a combination of an arc surface and at least one plane.

13. The device according to claim 12, wherein a direction of said arc surface of each of said positioning structures is different.

14. The device according to claim 12, wherein the number of said positioning structures is three, and directions of said arc surfaces of said adjacent positioning structures are different.

15. The device according to claim 12, wherein a direction of said arc surface of each of said positioning structures is the same.

16. The device according to claim 11, wherein a direction of an opening depth of each of said cutting grooves is parallel to a direction of said positioning structure of said buffer body corresponding thereto.

17. The device according to claim 11, wherein a direction of an opening depth of each of said cutting grooves is not parallel to a direction of said positioning structure of said buffer body corresponding thereto.

18. The device according to claim 1, wherein each of said buffer element is made of metal.

19. A removable dentures device assembly method, comprising the following steps:
a positioning step, comprising the following steps:
taking images of a denture framework provided with at least one buffer element, and a denture crown assembly to obtain a denture framework image of said denture framework and a denture crown assembly image of at least one accommodation groove of said denture crown assembly;
respectively determining a direction of a corresponding positioning arc surface of each of said buffer elements on said denture framework, and a direction of a corresponding positioning arc surface of each of said accommodation grooves of said denture crown assembly from said denture framework image and said denture crown assembly image; and
respectively determining a positions and direction of said buffer elements correspondingly provided on said denture framework, and positions and directions of said accommodation grooves according to said direction of said corresponding positioning arc surface of each of said buffer elements and said direction of said corresponding positioning arc surface of each of said accommodation grooves; and
an engagement step, positioning and engaging said denture crown assembly and said denture framework according to said positions and direction of said buffer elements and said accommodation grooves.

20. The method according to claim 19, wherein a step of determining said direction of said corresponding positioning arc surface of each of said buffer elements on said denture framework further comprising the following steps:
finding a positioning arc surface and an opposite plane of a positioning structure on said buffer element; and
setting a connection direction from a center of said plane of each of said buffer elements to a center of said positioning arc surface to be the direction of said corresponding positioning arc surface of each of said buffer elements.

21. The method according to claim 20, wherein a step of determining said positions and direction of said buffer elements correspondingly provided on said denture framework according to said direction of said corresponding positioning arc surface of each of said buffer elements further comprising the following steps:
connecting said center of said corresponding plane of each of said positioning structures to form a positioning point connection direction;
having a corresponding included angle between said positioning point connection direction and said connection direction of each of said positioning structures; and
determining a position and direction of said denture framework correspondingly provided on said buffer elements through said positioning point connection direction and said included angles.

22. The method according to claim 19, wherein a step of determining said positions and directions of said accommodation grooves according to said direction of said corresponding positioning arc surface of each of said accommodation grooves further comprising the follow steps:
finding a positioning arc surface and an opposite plane of each of said accommodation grooves; and
setting a connection direction from a center of said plane of each of said accommodation grooves to a center of said positioning arc surface to be the direction of said corresponding positioning arc surface of each of said accommodation grooves.

23. The method according to claim 22, wherein a step of determining said positions and directions of said accommodation grooves according to said direction of said corresponding positioning arc surface of each of said accommodation grooves further comprising the following steps:
connecting said center of said corresponding plane of each of said accommodation grooves to form a positioning point connection direction;
having a corresponding included angle between said positioning point connection direction and said connection direction of each of said accommodation grooves; and
determining positions and directions of said accommodation grooves through said positioning point connection direction and said included angles.
